(19) United States
(12) Patent Application Publication
(10) Pub. No.: US 2026/0134566 A1
(43) Pub. Date: May 14, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Hisayoshi FURIHATA, Tokyo (JP)

(21) Appl. No.: 19/372,414

(22) Filed: Oct. 29, 2025

(30) Foreign Application Priority Data
Nov. 11, 2024 (JP) 2024-196411

(51) Int. Cl. G06T 7/70

(52) U.S. Cl. CPC G06T 7/70

(57) ABSTRACT

In an information processing apparatus, a first position and orientation representing a relationship between a predetermined target terminal and a reference coordinate system is acquired, a second position and orientation representing a relationship between a first terminal and the target terminal is acquired, and a third position and orientation representing a relationship between the first terminal and the reference coordinate system is calculated based on the first position and orientation and the second position and orientation.

### BACKGROUND

### Field

The present disclosure relates to an information processing apparatus, an information processing method, a storage medium, and the like suitable for display of virtual objects and the like.

### Description of the Related Art

Technology known as MR (Mixed Reality), in which virtual objects (CG or text) are superimposed on video captured by a camera, is known. In MR, technology is used in which drawing positions of virtual objects are calculated in accordance with movement of terminals by estimating position and orientation of terminals (information terminals such as HMDs or smartphones) based on video information.

In order to draw virtual objects, a coordinate system that serves as an origin (hereinafter referred to as a reference coordinate system) is required somewhere in three-dimensional space. There are cases in which MR applications using markers set the reference coordinate system at positions of markers.

In addition, as a method for estimating position and orientation of terminals, as shown in Non-Patent Literature 1 (C. Campos, R. Elvira, J. J. G. Rodriguez, J. M. Montiel, and J. D. Tardos, ORB-SLAM3: An Accurate Open-Source Library for Visual, Visual-Inertial and Multi-Map SLAM, IEEE Transactions on Robotics 37 (6), December 2021), there is SLAM (Simultaneous Localization and Mapping) technology that does not require markers.

In addition, the reference coordinate system is often set in a case in which the reference coordinate system is set on planes such as floors or desks in three-dimensional space, in a case in which the reference coordinate system is set at an initial position of a camera, or in a case in which the reference coordinate system is set at arbitrary positions in accordance with input from users. In addition, position and orientation estimation methods of objects based on model fitting are generally known.

However, in a case in which markers are not used and a plurality of users each having a terminal want to experience MR, if each terminal sets a reference coordinate system separately, virtual objects are displayed at different positions in physical space for each terminal.

### SUMMARY

In an embodiment of the present disclosure, an information processing apparatus acquires a first position and orientation representing a relationship between a predetermined target terminal and a reference coordinate system, acquires a second position and orientation representing a relationship between a first terminal and the target terminal, and calculates a third position and orientation representing a relationship between the first terminal and the reference coordinate system based on the first position and orientation and the second position and orientation.

Further features of the present disclosure will become apparent from the following description of embodiments with reference to the attached drawings.

### BRIEF DESCRIPTION OF THE DRAWINGS

FIG. 1 is an image diagram showing a relationship example of two users and two terminals in a First Embodiment.

FIG. 2 is an image diagram showing a terminal (HMD) in the First Embodiment.

FIG. 3 is a block diagram showing a hardware configuration example of an information processing apparatus in the First Embodiment.

FIG. 4 is a functional block diagram of an information processing apparatus 510 of each terminal in the First Embodiment.

FIG. 5 is a flowchart showing a processing flow example of an information processing method executed by the information processing apparatus 510 of each terminal in the First Embodiment.

FIG. 6 is an image diagram for explaining relationships among a plurality of users and a plurality of terminals observed by sensors in a Second Embodiment.

FIG. 7 is a functional block diagram of an information processing apparatus 810 of each terminal in the Second Embodiment.

FIG. 8 is a flowchart showing a processing flow example of an information processing method executed by the information processing apparatus 810 in the Second Embodiment.

FIG. 9 is a functional block diagram of an information processing apparatus 1010 in a Third Embodiment.

FIG. 10 is a flowchart showing a processing flow example of an information processing method executed by the information processing apparatus 1010 in the Third Embodiment.

FIG. 11 is a UI image diagram for explaining a guidance example in a terminal of the Third Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

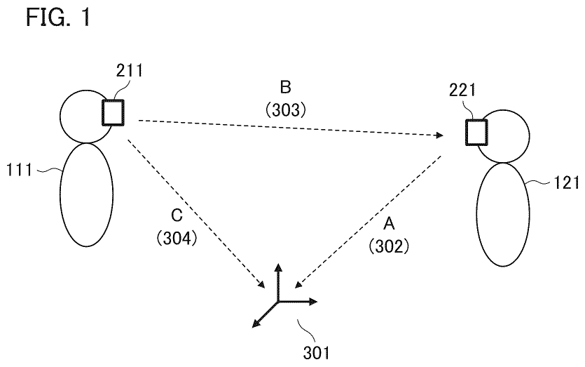

FIG. 1 is an image diagram showing a relationship example of two users and two terminals in a First Embodiment, and the information processing apparatus of the present embodiment is configured so that two terminals can share a single reference coordinate system.

111 and 121 are users who are attempting to experience MR. 211 is a terminal (HMD: Head-Mounted Display) worn by the user 111, and 221 is a terminal worn by the user 121. 301 is the reference coordinate system set in the terminal 221, and is the origin for displaying virtual objects.

It should be noted that the relationship between the terminal 221 and the reference coordinate system 301 is defined as position and orientation A (302), the relationship between the terminal 211 and the terminal 221 is defined as position and orientation B (303), and the relationship between the terminal 211 and the reference coordinate system 301 is defined as position and orientation C (304). It should be noted that the position and orientation A (302) is referred to as a first position and orientation, the position and orientation B (303) is referred to as a second position and orientation, and the position and orientation C (304) is referred to as a third position and orientation.

It should be noted that position and orientation referred to here is information having six degrees of freedom that represents a geometrical relationship between two objects, and A, B, and C are each represented by, for example, a 4×4 matrix.

In the present embodiment, a predetermined terminal in which position and orientation of the reference coordinate system 301 is set is referred to as a target terminal. In the present embodiment, the target terminal is the terminal 221, and position and orientation A (302) between the terminal 221 and the reference coordinate system 301 is assumed to be known.

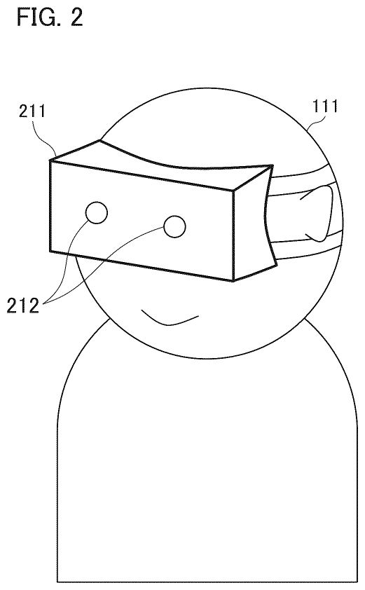

FIG. 2 is an image diagram showing a terminal (HMD) in the First Embodiment. The terminal 211 includes a camera 212, a display 213 (not shown) on an inner side of the terminal, and an information processing apparatus 510. Images captured using the camera 212 are displayed on the display 213, and the user 111 can visually recognize the images displayed on the display 213.

It should be noted that in the present embodiment, the terminal 211 and the terminal 221 have the same hardware configuration. Similarly, the terminal 221 includes a camera 222 (not shown), a display 223, and an information processing apparatus 520. However, the terminal 211 and the terminal 221 may include configurations different from each other.

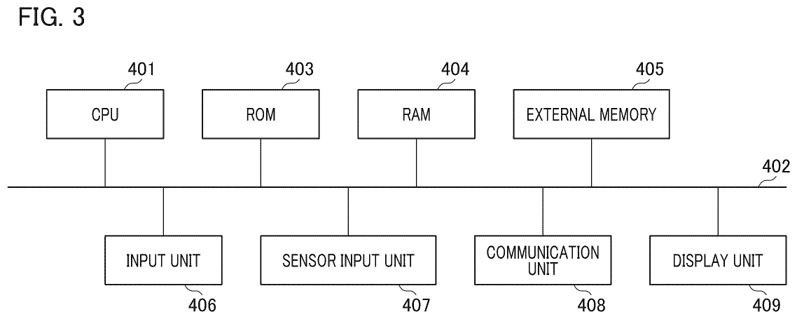

FIG. 3 is a block diagram showing a hardware configuration example of the information processing apparatus in the First Embodiment. 401 is a CPU, and performs control of various devices connected to the system bus 402. 403 is a ROM, and stores a BIOS program and a boot program.

404 is a RAM, and is used as the main memory of the CPU 401. 405 is an external memory, and stores a computer program for operating the information processing apparatus 510. 406 is an input unit that receives input from keyboards, mice, and touch panels, and performs processing related to input of information and the like.

407 is a sensor input unit, and acquires video from a camera provided in the terminal. 408 is a communication unit, and transmits and receives information to and from other terminals. 409 is a display unit, and outputs video information to the display provided in the terminal.

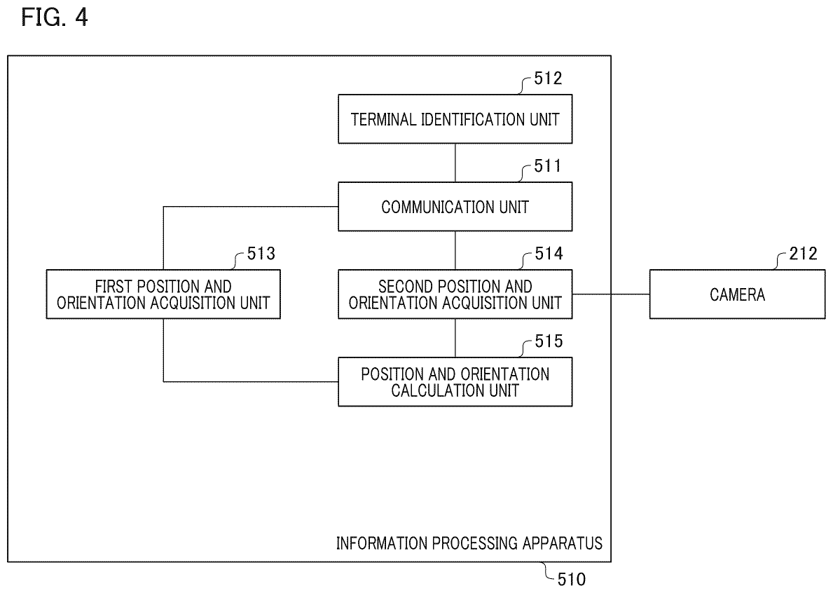

FIG. 4 is a functional block diagram of the information processing apparatus 510 of each terminal in the First Embodiment. It should be noted that part of the functional blocks shown in FIG. 4 is realized by causing a CPU 401 or the like, serving as a computer included in the information processing apparatus, to execute a computer program stored in a memory serving as a storage medium.

However, part or all thereof may be realized using hardware. For hardware, dedicated circuits (ASICs), processors (reconfigurable processors, DSPs), and the like can be used.

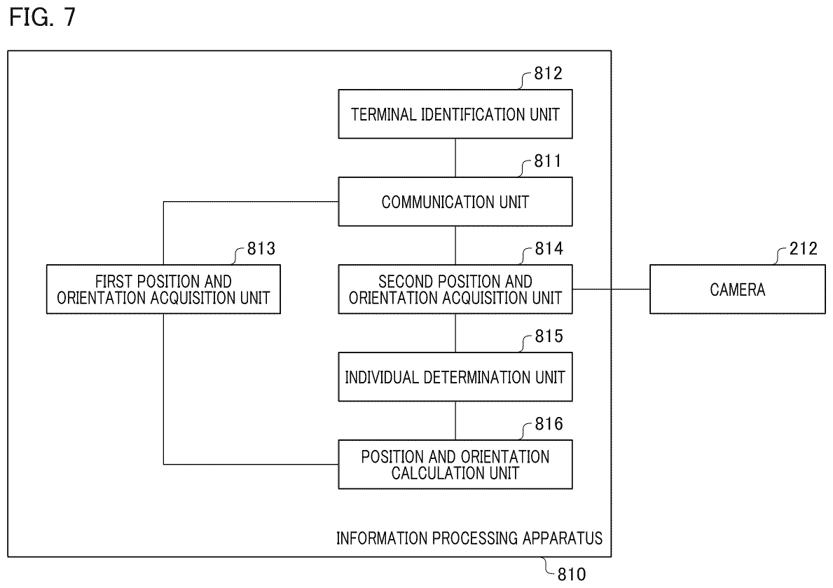

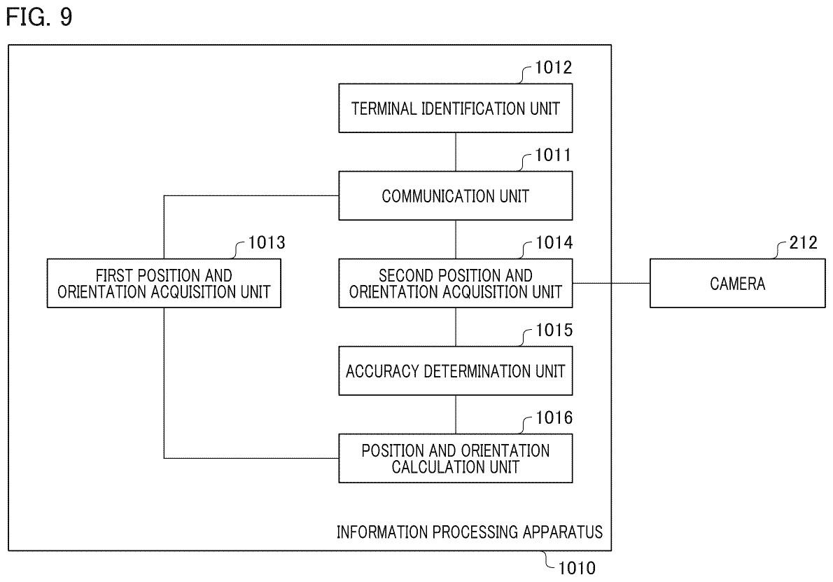

In addition, each functional block shown in FIG. 4 need not be built into the same housing, and each functional block may be configured by separate apparatuses connected to each other via signal paths. It should be noted that the above-described explanation with respect to FIG. 4 similarly applies to FIG. 7 and FIG. 9. It should be noted that the terminal 221 also has a configuration similar to that shown in FIG. 4.

511 is a communication unit for communicating information between terminals. In the present embodiment, wireless communication is performed, and information can be mutually transmitted to and received from other terminals. 512 is a terminal identification unit that identifies a target terminal in which the position and orientation of the reference coordinate system 301 is set. It should be noted that the terminal identification unit 512 functions as a terminal identification unit that identifies a target terminal in which position and orientation of a reference coordinate system is set.

513 is a first position and orientation acquisition unit that acquires a first position and orientation representing a relationship between the target terminal and the reference coordinate system 301, and functions as a first position and orientation acquisition unit.

514 is a second position and orientation acquisition unit that acquires a second position and orientation representing a relationship between the terminal of the apparatus (first terminal) and the target terminal, and functions as a second position and orientation acquisition unit.

515 is a position and orientation calculation unit that, based on the first position and orientation acquired by the first position and orientation acquisition unit 513 and the second position and orientation acquired by the second position and orientation acquisition unit 514, calculates the position and orientation (third position and orientation) of the reference coordinate system 301 with respect to the terminal 211.

It should be noted that the position and orientation calculation unit 515 functions as a position and orientation calculation unit for calculating a third position and orientation representing a relationship between the first terminal and the reference coordinate system based on the first position and orientation and the second position and orientation.

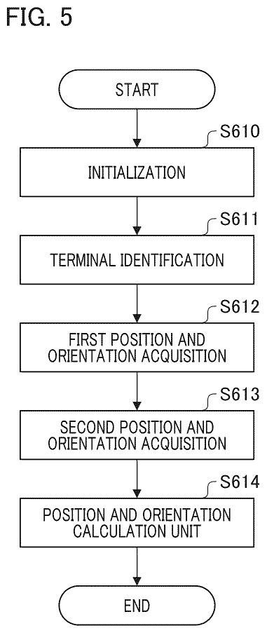

FIG. 5 is a flowchart showing a processing flow example of an information processing method executed by the information processing apparatus 510 of each terminal in the First Embodiment. It should be noted that operations of each step of the flowchart of FIG. 5 are performed sequentially by causing a CPU or the like serving as a computer in the information processing apparatus 510 of each terminal to execute a computer program stored in a memory.

It should be noted that the processing procedures using flowcharts in the following explanation are not limited to the examples, and any combination of procedures, consolidation of multiple processes, or subdivision of processes is possible provided that the results of the present disclosure are satisfied. In addition, each process can be individually extracted and function independently as a single functional element, and each process can be used in combination with processes other than the processes shown.

Based on the processing flow of FIG. 5, for example, an example of processing executed in the information processing apparatus 510 in the terminal 211 will be explained. In step S610, initialization of the information processing apparatus 510 of FIG. 4 is performed. That is, a computer program is read from the external memory 405 of FIG. 3, and the information processing apparatus 510 is brought into an operable state.

In step S611, the terminal identification unit 512 identifies a target terminal in which position and orientation of the reference coordinate system 301 is set.

In the present embodiment, for example, a terminal 221 serves as the target terminal, and position and orientation of the reference coordinate system 301 is assumed to have already been set for the terminal 221. Accordingly, the terminal identification unit 512, via the communication unit 511, confirms that position and orientation of the reference coordinate system 301 has been set for the terminal 221 and identifies the terminal 221 as the target terminal.

In step S612, the first position and orientation acquisition unit 513 acquires, via the communication unit 511, position and orientation representing a relationship between the target terminal and the reference coordinate system 301. Here, step S612 functions as a first position and orientation acquisition step of acquiring a first position and orientation representing a relationship between a predetermined target terminal and the reference coordinate system.

In the present embodiment, position and orientation A (302) between the terminal 221 serving as the target terminal and the reference coordinate system 301 is acquired. It should be noted that in the present embodiment, position and orientation A (302) is assumed to be the position and orientation set by the user 121 inputting position and orientation.

However, the position and orientation A (302) is not limited thereto, and may be set using any method. For example, the position and orientation A (302) may be set by image recognition based on images captured by the camera 222 of the terminal 221.

In step S613, the second position and orientation acquisition unit 514 acquires position and orientation representing a relationship between the terminal 211 of the apparatus and the terminal 221 serving as a target terminal. Here, step S613 functions as a second position and orientation acquisition step of acquiring a second position and orientation representing a relationship between the first terminal and the target terminal.

In the present embodiment, for example, position and orientation B (303) representing a relationship between the terminal 211 and the terminal 221 is estimated using, as input, image information captured by the camera 212 of the terminal 211. An estimation method for position and orientation B (303) may be any method, provided that the method estimates position and orientation of the housing of the terminal 221.

It should be noted that in the present embodiment, position and orientation are estimated based on model fitting using CAD data of the housing of the terminal 221. An object position and orientation estimation method based on model fitting may be any known method.

In step S614, the position and orientation calculation unit 515 calculates the position and orientation C (304) (third position and orientation) of the reference coordinate system 301 with respect to the terminal 211 based on the position and orientation A (302) (first position and orientation) and the position and orientation B (303) (second position and orientation).

Here, step S614 functions as a position and orientation calculation step for calculating a third position and orientation representing a relationship between the first terminal and the reference coordinate system based on the first position and orientation and the second position and orientation.

As described above, the position and orientation A (302) and the position and orientation B (303) are each 4×4 matrices having six degrees of freedom. The position and orientation C (304) of the reference coordinate system 301 with respect to the terminal 211 is calculated based on the position and orientation A (302) and the position and orientation B (303) using Equation 1.

$$C = A B \qquad Equation 1$$

In this manner, in FIG. 1, the position and orientation C (304) is the position and orientation of the reference coordinate system 301 with respect to the terminal 211, and indirect calculation is performed via the position and orientation A (302) and the position and orientation B (303). It should be noted that the position and orientation C (304), calculated by matrix multiplication of the position and orientation matrices, is also a 4×4 matrix having six degrees of freedom.

As explained above, in the present embodiment, the position and orientation A (302) of the reference coordinate system set in the terminal 221 serving as a target terminal is converted by using the relative position and orientation B (303) between terminals. Thereby, the position and orientation C (304) of the reference coordinate system with respect to the terminal 211 is calculated. By sharing the same reference coordinate system between two terminals in this manner, for example, virtual objects can be displayed at the same position in physical space in each terminal.

### Modification Example 1-1

In the First Embodiment, the first position and orientation acquisition unit 513 acquires position and orientation A (302) representing a relationship between the target terminal and the reference coordinate system 301 via the communication unit 511.

Here, position and orientation A (302) is set, for example, by user 121 of the terminal 221 serving as the target terminal by inputting position and orientation. However, any method may be used to set the position and orientation of the reference coordinate system 301 for the target terminal.

For example, position and orientation of the reference coordinate system may be set at a position on the ground recognized by sensors (not shown) of the terminal 221, or position and orientation of the reference coordinate system may be set by recognizing a marker. Predetermined fixed values may be used without using sensors.

### Modification Example 1-2

In the First Embodiment, the second position and orientation acquisition unit 514 acquired position and orientation B (303) representing a relationship between the terminal 211 of the apparatus and the terminal 221 that is a target terminal.

Specifically, although position and orientation representing a relationship between the terminal 211 and the terminal 221 was estimated using image information captured by the camera 212 included in the terminal 211 as input, any method may be used to estimate position and orientation between terminals. Recognizable objects such as markers may be arranged on surfaces of terminals and position and orientation between terminals may be estimated based on the markers, or heads of humans wearing terminals may be recognized and position and orientation of the heads may be estimated.

In addition, position and orientation representing a relationship between the terminal 211 and the terminal 221 may be estimated using, as input, image information captured by the camera 222 included in the terminal 221, instead of the terminal 211. In that case, the estimated position and orientation can be acquired in the terminal 211 via the communication unit 511. In addition, for example, position and orientation B (303) representing a relationship between the terminal 211 and the terminal 221 may be estimated by using radio waves and the like.

### Modification Example 1-3

In the First Embodiment, a terminal was assumed to be an HMD. However, a terminal may be of any type provided that the terminal has a camera for capturing image information and functions capable of information processing. For example, a smartphone having a camera may be used, or a PC provided with a camera may be used. Alternatively, autonomous mobile bodies such as an AGV having a camera may be used. In addition, each terminal may be of a different type.

### Modification Example 1-4

Although wireless communication was assumed for the communication unit 511 in the First Embodiment, any communication method may be used, provided that information can be transmitted to and received from a plurality of terminals, and communication may be wired.

### Modification Example 1-5

In the First Embodiment, position and orientation A (302) and position and orientation B (303) are assumed to be position and orientation that are set or estimated in a positional relationship between the terminal 211 and the terminal 221 at the same point in time.

However, in a case in which position and orientation A (302) and position and orientation B (303) are position and orientation that are set or estimated at different time points, there are cases in which errors are included due to the time lag. In consideration of the time lag, position and orientation A (302) and position and orientation B (303) may be corrected.

For example, using SLAM shown in Non-Patent Literature 1, how each terminal changed position and orientation in temporal sequence can be calculated. Here, time corresponding to position and orientation A (302) is defined as t1, and time corresponding to position and orientation B (303) is defined as t2.

Between t1 and t2, position and orientation change of the terminal 211 is defined as F, and position and orientation change of the terminal 221 is defined as G. For example, in a case in which position and orientation C (304) is calculated at time point t2, errors are included in position and orientation A acquired at time point t1 rather than at time point t2.

At that time, since position and orientation A (302) is position and orientation representing a relationship between the terminal 221 and the reference coordinate system 301, a correction becomes necessary using only G, wherein G is the position and orientation change of the terminal 221. Corrected position and orientation A′ can be calculated using Equation 2.

$${A}^{′} = GA \qquad Equation 2$$

### Modification Example 1-6

In the First Embodiment, the information processing apparatus 510 is provided in the terminal 211. However, in the present disclosure, an apparatus that calculates the position and orientation C (304) of the reference coordinate system with respect to the terminal 211 need not necessarily be provided in the terminal 211.

The information processing apparatus 510 may be provided on a separately prepared server, for example, or may be provided in the terminal 221 that is a target terminal. In a case in which the information processing apparatus 510 is disposed other than in the terminal 211, images captured by the camera 212 of the terminal 211 are transmitted to the server or the terminal 221 via the communication unit 511.

As described above, according to the present embodiment, even in a case in which terminals including a plurality of HMDs and the like are used, virtual objects can be displayed at the same position in physical space.

### Second Embodiment

Although the First Embodiment explained two users and two terminals, the present embodiment will explain an example of three users and three terminals. In a case in which two terminals exist other than the apparatus terminal, which terminal a sensor observes cannot be uniquely identified. The present embodiment will explain an example of determining an individual of a terminal that a sensor observes in a case in which three or more terminals exist.

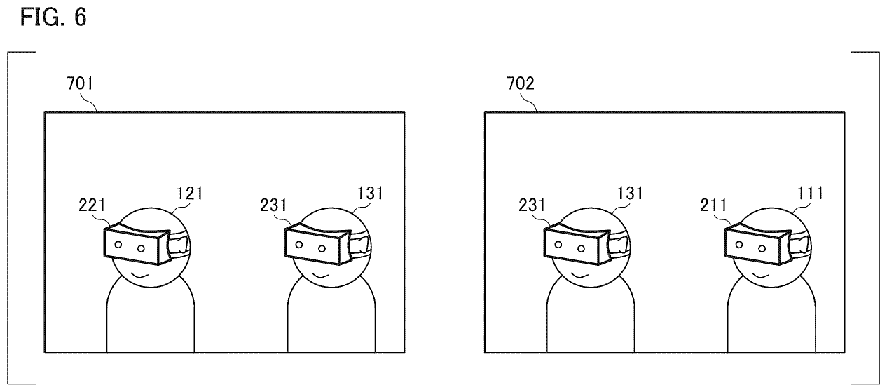

FIG. 6 is an image diagram for explaining relationships among a plurality of users and a plurality of terminals observed by sensors in the Second Embodiment. 701 is an image captured from the terminal 211 showing the user 121 and the terminal 221, and the user 131 and the terminal 231, and 702 is an image captured from the terminal 221 showing the user 131 and the terminal 231, and the user 111 and the terminal 211.

111, 121, and 131 in the drawings are each a user, and 211, 221, and 231 are each a terminal. In image 701, the user on the image capturing side is 111, and the terminal is 211. In image 702, the user on the image capturing side is 121, and the terminal is 221. It should be noted that in the Second Embodiment, although the terminal 211, the terminal 221, and the terminal 231 have the same hardware configuration, the terminal 211, the terminal 221, and the terminal 231 may include configurations different from one another.

FIG. 7 is a functional block diagram of an information processing apparatus 810 in each terminal in the Second Embodiment. It should be noted that 811 in FIG. 7 is the same functional block as 511 in the First Embodiment, 812 is the same functional block as 512, 813 is the same functional block as 513, and 816 is the same functional block as 515.

814 is a second position and orientation acquisition unit that acquires position and orientation representing a relationship between the terminal of the apparatus and a target terminal. In the present embodiment, assuming a case in which a plurality of terminals are observed, a plurality of positions and orientations are output as candidates for position and orientation of the target terminal.

815 is an individual determination unit that determines whether the position and orientation acquired by the second position and orientation acquisition unit 814 is the second position and orientation corresponding to the target terminal. It should be noted that the individual determination unit 815 functions as a determination unit that determines whether position and orientation representing a relationship between the first terminal and another terminal is the second position and orientation.

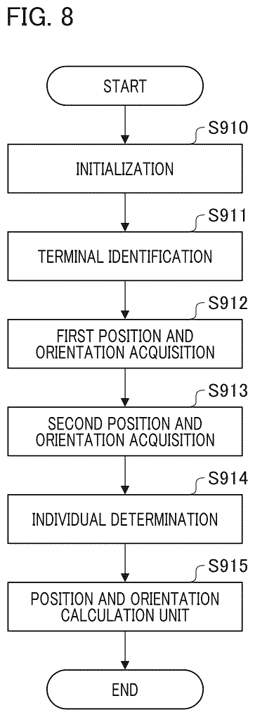

FIG. 8 is a flowchart showing a processing flow example of an information processing method executed by the information processing apparatus 810 in the Second Embodiment. It should be noted that operations of each step of the flowchart of FIG. 8 are performed sequentially by causing a CPU or the like serving as a computer in the information processing apparatus 810 to execute a computer program stored in a memory.

Based on FIG. 8, an example of a processing flow executed in the information processing apparatus 810 in the terminal 211, for example, will be explained. Here, step S910 of FIG. 8 is the same processing step as step S610 in the First Embodiment, step S911 is the same processing step as step S611 in the First Embodiment, step S912 is the same processing step as step S612 in the First Embodiment, and step S914 is the same processing step as step S614 in the First Embodiment. Step S913 and step S914 differ in processing from the First Embodiment as shown below.

In step S913, the second position and orientation acquisition unit 814 acquires position and orientation representing a relationship between the terminal 211 of the apparatus and a terminal that serves as a target terminal candidate.

First, the second position and orientation acquisition unit 814 estimates position and orientation of terminals appearing in the image, as in the First Embodiment. In the present embodiment, the terminal 221 is the target terminal, and the position and orientation calculation unit 816 described below uses position and orientation B (303) of the target terminal.

However, in a case in which three terminals exist, in the image of the camera 212 of the own terminal 211, terminals other than the terminal 221 serving as a target terminal (for example, the terminal 231) may be observed. Specifically, for example, consider a case in which two terminals, the terminal 221 that is a target terminal and the terminal 231, are observed in the image, as shown in the image 701 of FIG. 6.

In the second position and orientation acquisition unit 814, position and orientation of the terminal 221 and position and orientation of the terminal 231 in the image are acquired as candidates for the target terminal. Here, the acquired position and orientation of the terminal 221 is defined as B1, and the acquired position and orientation of the terminal 231 is defined as B2. It should be noted that the position and orientation of each terminal is estimated and acquired based on model fitting, similar to the First Embodiment.

In step S914, individual determination is performed. That is, the individual determination unit 815 determines whether the position and orientation acquired by the second position and orientation acquisition unit 814 is the position and orientation of the terminal 221 serving as a target terminal, for example.

Specifically, among the set of positions and orientations (B1, B2) acquired by the second position and orientation acquisition unit 814, the position and orientation corresponding to the terminal 221 serving as the target terminal is determined. In the present embodiment, determination is performed by confirming consistency in mutual position and orientation estimation between the terminal 211 and the terminal 221.

For that purpose, first, second position and orientation acquisition is also performed from the terminal 221 side in the same manner as the method shown in step S913. That is, the terminal 221 acquires position and orientation of the terminal 231 and the terminal 211 appearing in the image 702. The acquired position and orientation of the terminal 231 is defined as D1, and the acquired position and orientation of the terminal 211 is defined as D2.

D1 and D2 are acquired by the information processing apparatus 810 via the communication unit 811. Then, the respective positions and orientations are compared, and a consistent pair of positions and orientations is found. The four pair candidates are (B1, D1), (B2, D1), (B1, D2), and (B2, D2), and one pair among these is the pair in which the terminal 211 and the terminal 221 mutually estimated positions and orientations.

Assuming that positions and orientations of the terminals relative to each other have been estimated, position and orientation on one side matches an inverse matrix of position and orientation on the other side. In the present embodiment, by determining whether similarity between position and orientation on one side of the pair and an inverse matrix of position and orientation on the other side is within a threshold value, the pair representing mutual estimation of position and orientation between terminal 211 and terminal 221 is identified.

In this manner, in the present embodiment, based on images captured by a camera of the first terminal and images captured by a camera of the other terminal, determination is performed as to whether position and orientation representing a relationship between the first terminal and the other terminal is the second position and orientation.

In addition, at that time, by comparing a matrix of position and orientation of the other terminal, acquired based on images captured by a camera of the first terminal, and a matrix of position and orientation of the first terminal, acquired based on images captured by a camera of the other terminal, the above-described determination is performed.

In the present embodiment, assume that (B1, D1) is a pair that satisfies conditions. In this case, B1 can be determined to be the position and orientation of the terminal 221 as viewed from the side of the terminal 211. Thereafter, by using B1 as the position and orientation B (303) between the terminal 211 and the terminal 221, the position and orientation calculation unit 816 can calculate the position and orientation C (304) of the reference coordinate system 301 with respect to the terminal 211.

As explained above, in the present embodiment, even in a case in which there are three users and three terminals, for example, a reference coordinate system can be shared between certain terminals (the terminal 211 and the terminal 221). It should be noted that with respect to the remaining terminal 231, coordinates can be shared by performing processing similar to the present embodiment using the terminal 211 or the terminal 221 as a target.

Thereby, in each of the three terminals, virtual objects can be displayed at the same position in physical space. In addition, because the calculation can be performed in the same manner even under conditions where four or more terminals exist, a reference coordinate system can be shared among any number of terminals.

### Modification Example 2-1

In the Second Embodiment, the individual determination unit 815 performed determination by confirming consistency in the mutual position and orientation estimation between the terminal 211 and the terminal 221.

However, the above-described determination method may be any method, provided that the method is a method for determining what terminal the terminal observed by sensors corresponds to. Markers by which an individual terminal can be uniquely identified may be attached to the terminals, and determination may be performed by recognizing the markers, or determination may be performed based on whether movement of a terminal observed by sensors in temporal sequence and movement obtained by self-position and orientation estimation of the corresponding terminal match.

### Third Embodiment

In the First Embodiment, the second position and orientation acquisition unit estimates position and orientation based on images. In a case in which position and orientation is estimated from images, for example, under conditions in which a part of a terminal is occluded at screen edges, estimation accuracy becomes low. Accordingly, in the Third Embodiment, only positions and orientations between terminals that have been estimated with high accuracy are used.

FIG. 9 is a functional block diagram of an information processing apparatus 1010 in the Third Embodiment. Here, 1011 of FIG. 9 has the same function as 511 in the First Embodiment, 1012 has the same function as 512, 1013 has the same function as 513, 1014 has the same function as 514, and 1016 has the same function as 515.

1015 is an accuracy determination unit that determines whether or not position and orientation acquired by the second position and orientation acquisition unit 1014 satisfies predetermined conditions of accuracy. Here, the accuracy determination unit 1015 functions as an accuracy determination unit that determines whether or not position and orientation acquired by the second position and orientation acquisition unit satisfies predetermined conditions of accuracy.

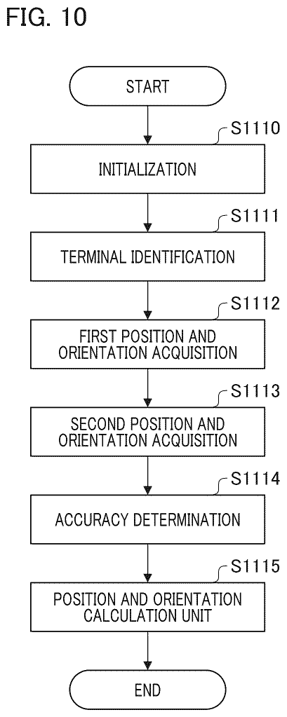

FIG. 10 is a flowchart showing a processing flow example of an information processing method executed by the information processing apparatus 1010 in the Third Embodiment. It should be noted that operations of each step of the flowchart of FIG. 10 are performed sequentially by causing a CPU or the like serving as a computer in the information processing apparatus 1010 to execute a computer program stored in a memory.

Based on FIG. 10, an example of a processing flow executed in the information processing apparatus 1010 in the terminal 211, for example, will be explained. Here, step S1110 of FIG. 10 is the same processing step as step S610 in the First Embodiment, step S1111 is the same processing step as step S611, step S1112 is the same processing step as step S612, step S1113 is the same processing step as step S613, and step S1115 is the same processing step as step S614. Step S1114 differs in processing from the First Embodiment as shown below.

In step S1114, the accuracy determination unit 1015 determines whether position and orientation of a terminal serving as a target terminal candidate acquired by the second position and orientation acquisition unit 1014 satisfies conditions of accuracy.

Specifically, in the present embodiment, whether the acquired position and orientation of a terminal serving as a target terminal candidate is within a predetermined range is determined. First, the condition for the highest-accuracy estimation of position and orientation is considered to be the condition in which the terminal serving as a target terminal candidate is at the center of the image and the terminal faces forward toward the camera of the terminal 211.

When the position and orientation is defined as X, accuracy can be expected to become lower as distance from position and orientation X increases. For example, in a case in which a part of an image of a terminal extends outside the screen, in a case in which the terminal is separated too far in the depth direction and the image of the terminal on the screen is too small, or in a case in which the terminal is facing sideways and the shape of the terminal is difficult to recognize sufficiently, accuracy is determined to be low.

In the present embodiment, position and orientation acquired by the second position and orientation acquisition unit 1014 is defined as B (303), and whether conditions of accuracy are satisfied is determined by determining whether the difference between the above-described position and orientation X and position and orientation B (303) is within a predetermined value.

In a case in which conditions are satisfied, thereafter, by using the position and orientation B (303), the position and orientation calculation unit 1016 can calculate the position and orientation of the reference coordinate system 301 with respect to the terminal 211 with high accuracy.

As explained above, in the Third Embodiment, by using only position and orientation that satisfies conditions of accuracy as determined by the accuracy determination unit 1015, position and orientation of the reference coordinate system 301 with respect to the terminal 211 can be estimated accurately. Thereby, virtual objects can be displayed accurately at the same position in physical space for each terminal.

### Modification Example 3-1

In the Third Embodiment, the accuracy determination unit 1015 determined whether the position and orientation acquired by the second position and orientation acquisition unit 1014 was within a predetermined range.

However, the accuracy determination method may be any method provided that the method determines whether the accuracy of the position and orientation to be acquired is high. For example, when movement speed of a terminal on the screen is fast, the position and orientation thereof cannot be estimated with high accuracy due to the influence of motion blur.

By using that tendency, when the amount of change over time in the position and orientation acquired by the second position and orientation acquisition unit 1014 is small, the accuracy of the position and orientation may be determined to be high, and conversely in a case in which movement speed is fast, the accuracy of the position and orientation may be determined to be low.

That is, the accuracy determination unit 1015 serving as an accuracy determination unit may be configured to determine whether or not the position and orientation acquired by the second position and orientation acquisition unit satisfies at least one condition of a predetermined position and orientation range and a predetermined speed range.

In addition, a ratio of occlusion by hands or other objects may be calculated, and when the ratio of occlusion is small, the accuracy of the position and orientation may be determined to be high. In addition, the above-described methods may be used in combination.

### Modification Example 3-2

The information processing apparatus 1010 is provided with a guidance unit 1017 (not shown), and may provide guidance to the user so as to increase the accuracy of the position and orientation. That is, based on determination results of the accuracy determination unit 1015, a guidance unit may be provided to perform guidance so that position and orientation acquired by the second position and orientation acquisition unit falls within a predetermined position and orientation range.

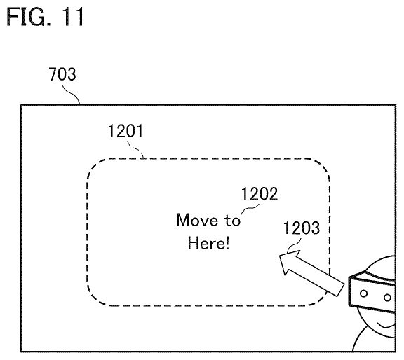

FIG. 11 is a UI image diagram for explaining a guidance example in a terminal of the Third Embodiment. 703 is an image displayed on the display 213 of the terminal 211. A frame 1201 is displayed at a central part of the image 703, and text 1202, an arrow 1203, and the like may be displayed as guidance so that the display position of the other terminal in the image 703 moves to the frame 1201.

By viewing these guidance displays, the user can understand the direction to orient the camera of the terminal 211 and therefore can increase acquisition accuracy of position and orientation between terminals.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2024-196411, filed on Nov. 11, 2024, which is hereby incorporated by reference herein in its entirety.

What is claimed is:

1. An information processing apparatus comprising:
at least one processor; and
a memory coupled to the at least one processor, the memory storing instructions that, when executed by the at least one processor, cause the at least one processor to:
acquire a first position and orientation representing a relationship between a predetermined target terminal and a reference coordinate system,
acquire a second position and orientation representing a relationship between a first terminal and the target terminal, and
calculate a third position and orientation representing a relationship between the first terminal and the reference coordinate system based on the first position and orientation and the second position and orientation.

2. The information processing apparatus according to claim 1, wherein the memory stores further instructions that, when executed by the at least one processor, cause the at least one processor to identify the target terminal in which position and orientation of the reference coordinate system is set.

3. The information processing apparatus according to claim 1, wherein the memory stores further instructions that, when executed by the at least one processor, cause the at least one processor to determine whether or not position and orientation representing a relationship between the first terminal and the other terminal is the second position and orientation.

4. The information processing apparatus according to claim 3, wherein, in the determination, whether or not position and orientation representing a relationship between the first terminal and the other terminal is the second position and orientation is determined based on images respectively captured by a camera of the first terminal and by a camera of the other terminal.

5. The information processing apparatus according to claim 4, wherein, in the determination, the determination is performed by comparing a matrix of position and orientation of the other terminal acquired based on images captured by a camera of the first terminal and a matrix of position and orientation of the first terminal acquired based on images captured by a camera of the other terminal.

6. The information processing apparatus according to claim 1, wherein the memory stores further instructions that, when executed by the at least one processor, cause the at least one processor to determine whether or not the second position and orientation satisfies a predetermined accuracy.

7. The information processing apparatus according to claim 6, wherein, in the determination of the accuracy, it is determined whether or not the second position and orientation satisfies at least one condition of a predetermined position and orientation range and a predetermined speed range.

8. The information processing apparatus according to claim 6, wherein the memory stores further instructions that, when executed by the at least one processor, cause the at least one processor to perform guidance based on a determination result in the accuracy determination, so that the second position and orientation falls within a predetermined position and orientation range.

9. An information processing method comprising:
acquiring a first position and orientation representing a relationship between a predetermined target terminal and a reference coordinate system,
acquiring a second position and orientation representing a relationship between a first terminal and the target terminal, and
calculating a third position and orientation representing a relationship between the first terminal and the reference coordinate system based on the first position and orientation and the second position and orientation.

10. A non-transitory computer-readable storage medium configured to store a computer program comprising instructions for executing the following processes:
acquiring a first position and orientation representing a relationship between a predetermined target terminal and a reference coordinate system,
acquiring a second position and orientation representing a relationship between a first terminal and the target terminal, and
calculating a third position and orientation representing a relationship between the first terminal and the reference coordinate system based on the first position and orientation and the second position and orientation.
